(19) United States
(12) Patent Application Publication
(10) Pub. No.: US 2003/0007362 A1
(43) Pub. Date: Jan. 9, 2003

(54) Vehicle side mirror assembly including sequentially lighted LED turn signal indicator

(76) Inventor: David L. Robison, Dearborn, MI (US)

Correspondence Address: HARNESS, DICKEY & PIERCE, P.L.C., P.O. BOX 828, BLOOMFIELD HILLS, MI, 48303, US

(21) Appl. No.: 09/899,497

(22) Filed: Jul. 5, 2001

(51) Int. Cl. B60Q 1/00

(52) U.S. Cl. 362/487

(57) ABSTRACT

A vehicle side mirror assembly including a lighted turn signal indicator. The side mirror assembly is configured to replace an existing side mirror assembly for mounting to known mirror scalps. The mirror glass is mounted to a rearward facing surface of a base plate of the mirror assembly by a piece of two-sided tape or heater panel. A printed circuit board is mounted to a forward facing surface of the base plate within a suitably shaped cavity. LEDs mounted to the circuit board are aligned with holes in the base plate. The circuit board is inserted into the cavity from an opposite side of the base plate from the mirror glass. A cover is sonically welded to the base plate to cover the cavity and hold the circuit board therein. The LEDs are illuminated in a sequential manner starting with an outermost pair of LEDs to an inner most LED.

### BACKGROUND OF THE INVENTION

1. Field of the Invention

This invention relates generally to a vehicle side mirror including a lighted turn signal indicator and, more particularly, to a vehicle side mirror assembly including a lighted turn signal indicator having sequentially illuminated LEDs, where the circuit for controlling the LEDs is mounted within the assembly.

2. Discussion of the Related Art

Vehicle side mirrors are typically provided on both sides of a motor vehicle that extend away from the side of the vehicle to give the vehicle operator right and left side rearward views for lane changing and the like. Current side mirror designs typically employ a stylized mirror shell or housing making up a forward facing portion of the side mirror, and a side mirror assembly, including the mirror glass, facing in a rearward direction. Typically, the mirror assembly is removably mounted to a mirror motor bracket located within the mirror housing, and can be replaced with other mirror assemblies when necessary due to breakage or other causes. The mirror assembly is mounted to the mirror bracket in such a manner that an electric motor or manual adjuster can pivot the mirror to provide directional control for the vehicle operator.

It has heretofore been known in the art to provide a lighted turn signal indicator in the vehicle side mirror. Known designs include providing an incandescent bulb in a rearwardly facing portion of the mirror skull cap adjacent to an outer end of the mirror housing. When the vehicle operator activates the turn signal indicator, the lamp flashes on the appropriate side of the vehicle to provide an indication to other motorists that the operator wishes to make a turn. In another known design, a light source is configured into a “V-shape,” and is formed behind a reflective dichroic coating of the mirror glass. Activating the light source causes it to visibly flash through the glass indicating a left or right hand turn. In yet another known design, holes are provided through the mirror glass reflective coating in a “V-shape”, and LEDs are positioned behind the holes so that light from the LEDs shines therethrough. In this design, the LEDs are activated when a turn is desired, and the LEDs flash in conjunction with the vehicle turn signal as a unit. Other designs are also known in the art, where a light source in both of the side mirrors provides an indication to other motorists of the direction the vehicle operator is turning.

Various improvements can be made in the state of art to provide a more visually appealing and cost effective technique for providing a lighted turn signal indicator in the mirror glass of a vehicle side mirror assembly. It is therefore an object of the present invention to provide such a side mirror assembly.

### SUMMARY OF THE INVENTION

In accordance with the teachings of the present invention, a vehicle side mirror assembly including a lighted turn signal indicator is disclosed. The side mirror assembly is configured to replace an existing side mirror assembly mounted within known mirror housings. The mirror glass of the assembly includes a reflective coating having a series of holes configured in a V-shape. The mirror glass is mounted to a rearward facing surface of a base plate of the mirror assembly by a mounting medium, such as a piece of two-sided tape or a mirror heater panel. A printed circuit board is mounted to a forward facing surface of the base plate within a suitably shaped cavity. LEDs mounted to the circuit board are aligned with holes in the base plate, holes in the mounting medium and the holes in the reflective coating. The circuit board is inserted into the cavity from an opposite side of the base plate from the mirror glass. A cover is sonically welded to the base plate to cover the cavity and hold the circuit board therein.

In an alternate embodiment, the size of the mirror glass is reduced so that it does not cover the LEDs on the base plate. In this design, the LEDs are positioned outside the periphery of the mirror glass, and a lens is mounted over the LEDs, where the lens is made of a material so that the illumination of the LEDs is visible therethrough.

When the vehicle operator wishes to make a turn, the turn signal switch is activated, which sends a signal to the circuit board to energize the LEDs. The LEDs are illuminated in a sequential manner starting with an outer most pair of LEDs to an inner most LED. The sequential lighting of the LEDs is continued through the sequence until all of the LEDs are lit. The LEDs then remain lit until the turn signal switch is deactivated.

Further areas of applicability of the present invention will become apparent from the detailed description provided hereinafter. It should be understood that the detailed description and specific examples, while indicating certain embodiments of the invention, are intended for purposes of illustration only and are not intended to limit the scope of the invention.

### BRIEF DESCRIPTION OF THE DRAWINGS

FIG. 1 is a perspective view of a side mirror attached to a vehicle, including a side mirror housing and a side mirror assembly, according to an embodiment of the present invention;

FIG. 2 is an exploded perspective view of the side mirror assembly shown in FIG. 1;

FIG. 3 is a rearward facing view of a base plate associated with the side mirror assembly shown in FIG. 1;

FIG. 4 is a forward facing view of the side mirror assembly shown in FIG. 1 with a circuit board cover removed;

FIG. 5 is a top view of the circuit board removed from the side mirror assembly;

FIG. 6 is a perspective view of a side mirror attached to a vehicle, including a side mirror housing and side mirror assembly, according to another embodiment of the present invention;

FIG. 7 is an exploded perspective view of the side mirror assembly shown in FIG. 6; and

FIG. 8 is a schematic diagram of the circuit in the circuit board shown in FIG. 5.

### DETAILED DISCUSSION OF THE EMBODIMENTS

The following discussion of the preferred embodiments directed to a side mirror assembly for a vehicle, including sequentially illuminated LEDs for turn signal indication, is merely exemplary in nature, and is in no way intended to limit the invention, or its application or uses.

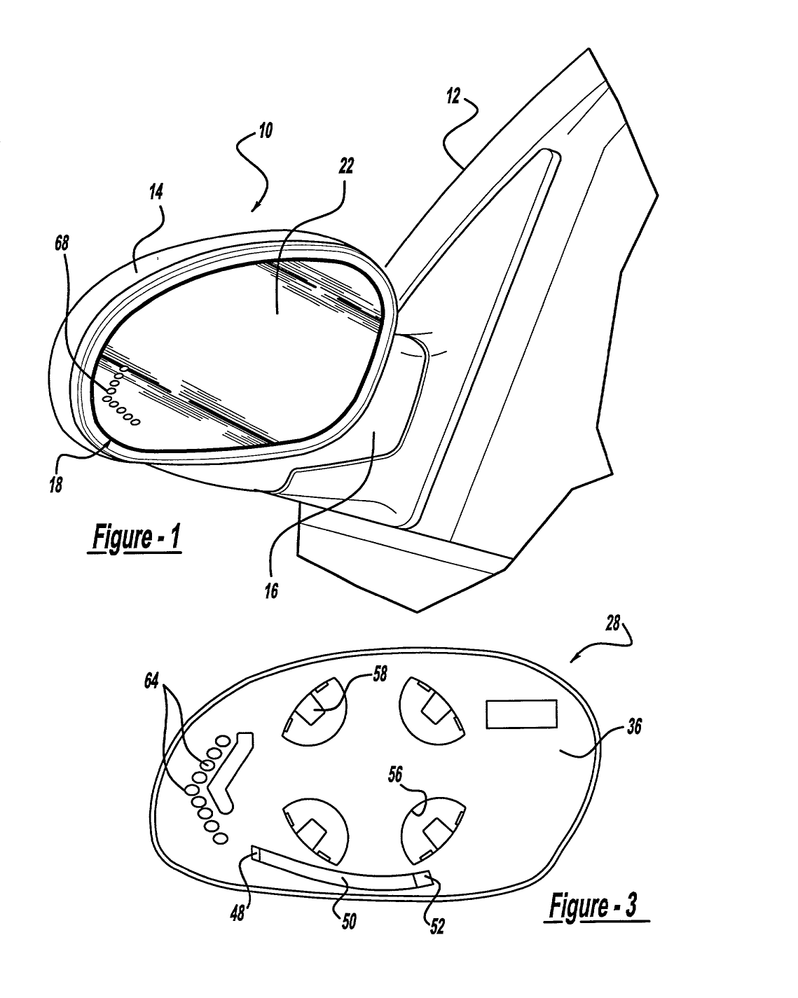

FIG. 1 is a perspective view of a vehicle side mirror 10 mounted to a vehicle 12 at the usual location and in the usual manner. The side mirror 10 includes a forward facing mirror housing 14, a mounting portion 16 and a rearward facing, removable mirror assembly 18, according to an embodiment of the present invention. The mirror housing 14 and the mounting portion 16 combine to form a decorative mirror housing, as is well understood to those skilled in the art. The mirror assembly 18 is removably mounted to the mirror housing 14 in any known manner, and is pivotally mounted therein so that a rearwardly facing mirror glass 22 associated with the assembly 18 can be angled in different directions to accommodate different vehicle operators and driving conditions. The mirror glass 22 has a “Chevron” shape, however, other shapes can be used in other designs within the scope of the present invention. The mirror assembly 18 of the present invention is intended to replace existing mirror assemblies, so that it can be mounted to various mirror housings or mirror scalps in the conventional manner.

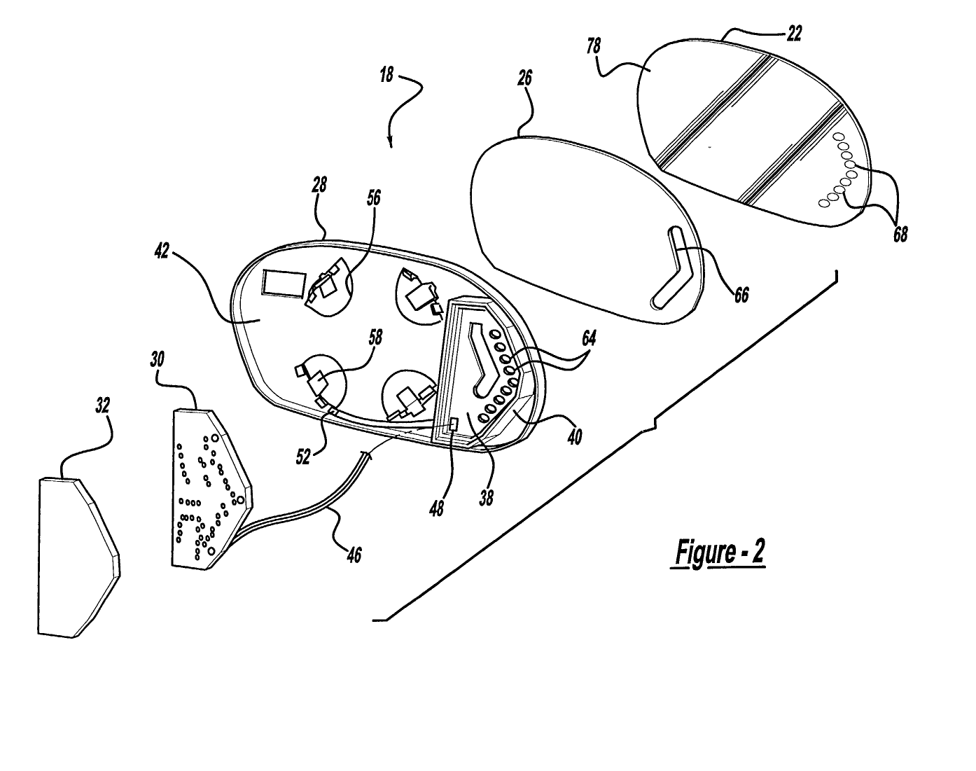

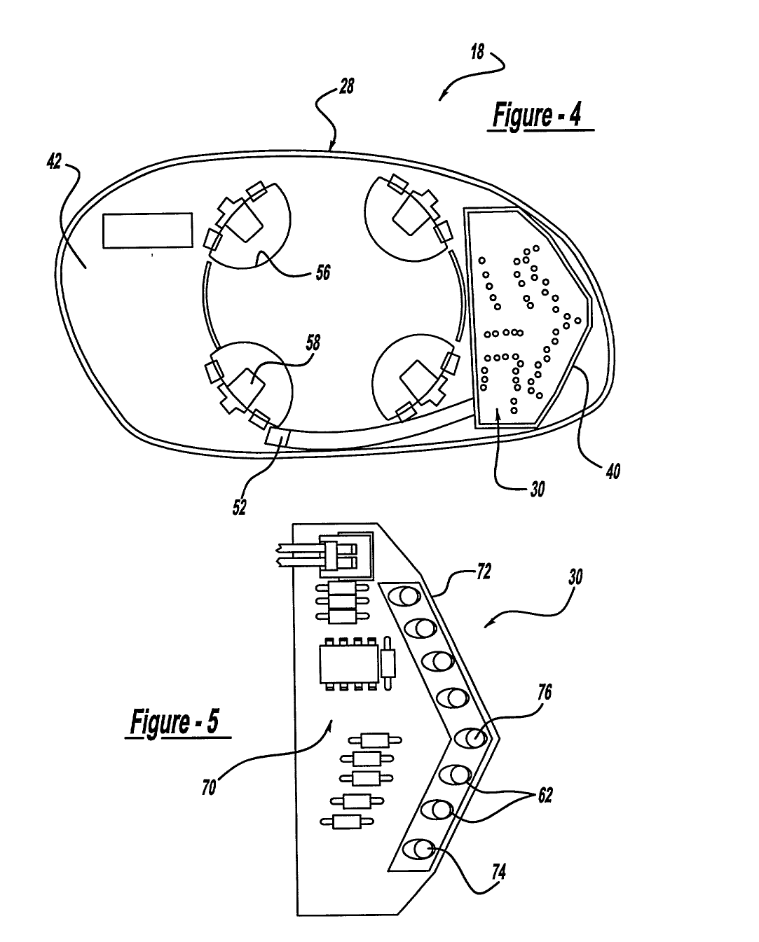

FIG. 2 is an exploded perspective view of the mirror assembly 18 separated from the mirror housing 14. According to the invention, the mirror assembly 18 includes the mirror glass 22, a piece of two-sided tape 26, a base plate 28, a printed circuit board 30 and a printed circuit board cover 32, all of which will be described in more detail below. The tape 26 can be replaced with a mirror glass heater panel. The circuit board 30 controls operation of a lighted turn signal indicator visible through the mirror glass 22. FIG. 3 is a rearward facing view of the base plate 28, FIG. 4 is a forward facing view of the base plate 28 with the cover 32 removed, and FIG. 5 is a top view of the printed circuit board 30 separated from the assembly 18.

The mirror glass 22 is mounted to a rearward facing surface 36 of the base plate 28 by the two-sided tape 26. The printed circuit board 30 is mounted in a cavity 38 formed by walls 40 on a forward facing surface 42 of the base plate 28. The cover 32 covers the cavity 38, and is sonically welded to the walls 40 to hold the cover 32 to the base plate 28 and secure the circuit board 30 within the cavity 38. Other techniques, such as glue, can be used to secure the cover 32 to the base plate 28. As is apparent, the circuit board 30 and the cover 32 are assembled to the base plate 28 from a forward facing direction or “back” of the assembly 18. This assembly technique provides advantages for ease of manufacture, and thus, a reduction in manufacturing cost.

Electrical wires 46 from the circuit board 30 extend through an opening 48 within the cavity 38 in the base plate 28 to the rearward facing surface 36. The wires 46 extend down a channel 50 open to the surface 36, and back through another opening 52 in the base plate 28, but outside of the cavity 38, to the forward facing surface 42. The wires 46 then extend into the mirror housing 14, through the mounting portion 16 and into the vehicle 12, where they are electrically connected to the appropriate turn signal control circuit (not shown), as would be well understood to those skilled in the art. In this configuration, the cavity 38 is sealed by the cover 32 at one side and by the twosided tape 26 at the other side so that moisture does not effect the circuit board 30.

The base plate 28 includes four openings 56 and tabs 58 for mounting the plate 28 to an existing motor or adjuster. This is an example of one attachment scheme. Other methods can be used for attaching the assembly 18 to the various motors and adjusters used in the industry as new mirror assemblies are developed, as would be appreciated by those skilled in the art. These methods will vary from mirror to mirror and allow the assembly 18 to be mounted to the motor or adjuster. The motor unit pivots the assembly 18 in response to signals from a mirror control device (not shown), or by manual operation, as controlled by the vehicle operator.

The circuit board 30 includes a plurality of light emitting diodes (LEDs) 62 electrically connected thereto. This embodiment employs nine LEDs 62, although more or less LEDs can be used in other designs. The LEDs 62 are arranged in a V-shape to provide a pointing direction. However, in alternate embodiments, the arrangement of the LEDs can be in other shapes consistent with the discussion herein. The circuit board 30 includes electrical components 70 that illuminate the LEDs 62 in the manner described herein. When the circuit board 30 is mounted in the cavity 38, the LEDs 62 align with a plurality of holes 64 in the base plate 28. Likewise, the holes 64 align with a slot 66 in the tape 26 and with holes 68 in a reflective layer 78 of the mirror glass 22. Therefore, when the LEDs 62 are illuminated, they are visible through the glass 22.

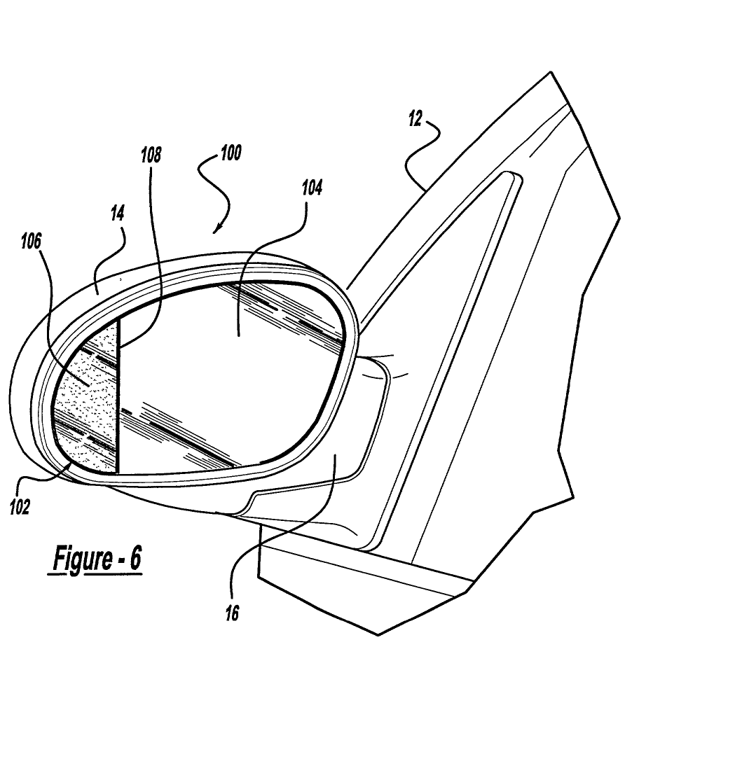

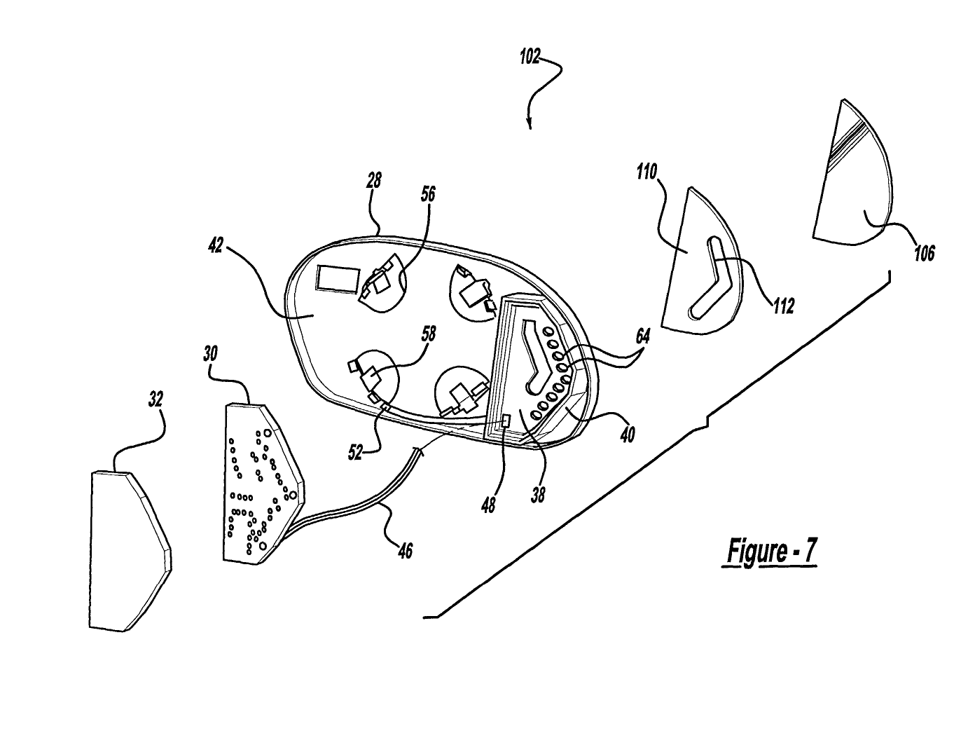

FIG. 6 is a perspective view of a vehicle side mirror 100 mounted to the vehicle 12 and FIG. 7 is an exploded perspective view of a mirror assembly 102 separated from the mirror housing 14, according to another embodiment of the present invention. FIGS. 6 and 7 represent another embodiment of the present invention where the LEDs 62 are removed from behind the mirror glass 22 so that they are outboard therefrom. In these figures, like components to the embodiments discussed above are identified with the same reference numeral.

The mirror glass 22 has been replaced with mirror glass 104 in this embodiment, where the outer end of the mirror glass 104 has been removed as shown. The removed portion of the mirror glass 104 is replaced with a lens 106 that is translucent or transparent to allow light from the LEDs 62 to shine through. The lens 106 can be completely clear or can be smoked, or can be any degree of transparency suitable for the purposes discussed herein. In one embodiment, the lens 106 is made of a suitable plastic, such as acrylic or a polycarbonate, however, other materials can be used, as would be appreciated by those skilled in the art. A rib 108 is formed in the base plate 36 to separate the mirror glass 104 from the lens 106, as shown. In FIG. 7, the mirror glass 104 has already been mounted to the base plate 36 by a suitable piece of twosided tape or the like. The lens 106 is shown in exploded view, where a piece of two-sided tape 110 including a slot 112 allows the lens 106 to be mounted to the base plate 36 so that the LEDs 62 are visible through the tape 110.

According to the invention, the LEDS 62 are illuminated in a sequential manner. Particularly, when the circuit board 30 receives a signal from the turn signal control circuit in the vehicle 12, the LEDs 62 are activated so that an outermost pair of LEDs 72 and 74 are simultaneously illuminated first. In sequence, a next outermost pair of LEDs are simultaneously illuminated and then a next outermost pair of LEDs are simultaneously illuminated, until an LED 76 at the point of the V-shape is illuminated. At this point, all of the LEDs 62 in the array are illuminated and stay lit until they are switched off by the vehicles internal turn signal circuit. In other words, as each pair of LEDs 62 are illuminated, the pairs of LEDs 62 that were previously illuminated stay lit, until all of the LEDs 62 are illuminated. The time period each pair of LEDs 62 is illuminated before the next pair is illuminated can be selectively set by a time constant in the circuit.

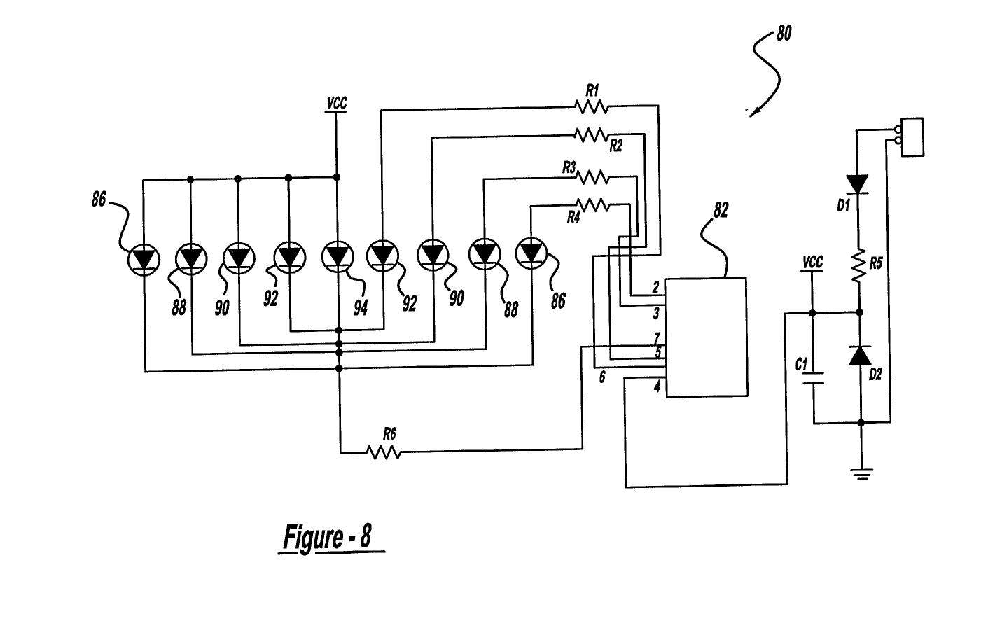

The circuit that controls the sequential illumination of the LEDs 62 can be any circuit suitable for the purposes described herein. FIG. 8 is a schematic diagram of a circuit 80 that provides this function, according to one embodiment. The circuit 80 includes a microprocessor 82, LEDs 84 representing the LEDs 62, resistors R1-R6, diodes D1 and D2 and capacitor C1. The microprocessor 82 can be any processor suitable for the purposes described herein, such as the PIC 12C5XX, known to those skilled in the art. The microprocessor 82 uses a two-pin header for power consumption. Power is regulated with the resistor R5 and the zener diode D2. The circuit 80 is reverse polarity protected by the diode D1.

When power is applied to the circuit 80 from the turn signal control circuit in the vehicle, the microprocessor 82 illuminates the two outermost LEDs 86 by grounding pin 2. The outermost LEDs 86 are connected in series with Vcc so that they light simultaneously. The microprocessor 82 delays 75 milliseconds while the LEDs 86 are illuminated, and then grounds pin 3 so that the next pair of outermost LEDs 88 are simultaneously illuminated. This sequence repeats by lighting the LED pair 90 and 92 in sequence until a center LED 94 is illuminated, which is the only LED that is not paired with another where all of the LEDs are illuminated. The time period of the sequence until the center LED is illuminated is 300 milliseconds. All of the LEDs 84 are maintained illuminated for 200 milliseconds, giving the time of the sequence to be 500 milliseconds. The sequence is repeated with the vehicle turn signal cycle from circuit 80. It should be understood that the time values given herein are by way of a non-limiting example.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. A mirror assembly for a vehicle side mirror, said assembly comprising:
a base plate having a forward facing surface and a rearward facing surface, said base plate including a plurality of holes extending therethrough;
a mirror glass mounted to the rearward facing surface of the base plate, said mirror glass including a reflective layer having a plurality of holes extending therethrough, said reflective layer holes being aligned with the base plate holes;
a plurality of LEDs mounted to the forward surface of the base plate, said LEDs being aligned with the holes in the base plate and the holes in the reflective layer so that illumination of the LEDs can be seen through the mirror glass; and
a control device, said control device causing the LEDs to be sequentially illuminated from an outermost pair of LEDs to an inner LED where a first pair of LEDs is illuminated, then a next pair of LEDs is illuminated in sequence towards the inner LED.

2. The assembly according to claim 1 wherein the control device sequentially illuminates the LEDs so that each pair of LEDs that is illuminated remain lit as the next inner most pair of LEDs is illuminated.

3. The assembly according to claim 2 wherein the control device causes the LEDs to be sequentially illuminated until all of the LEDs are lit, said control device causing the LEDs to remain illuminated until a power signal is removed from the LEDs.

4. The assembly according to claim 1 wherein the plurality of LEDs and the control device are mounted on a printed circuit board, and wherein the printed circuit board is mounted within a cavity formed in the forward facing surface of the base plate.

5. The assembly according to claim 4 wherein the circuit board is held within the cavity by a cover plate.

6. The assembly according to claim 5 wherein the cover plate is sonically welded to the forward facing surface of the base plate.

7. The assembly according to claim 4 wherein the base plate includes a first opening within the cavity and a second opening outside of the cavity, and wherein a wire electrically connected to the circuit board extends through the first opening to the rearward facing surface of the base plate and then extends through the second opening from the rearward facing surface to the forward facing surface.

8. The assembly according to claim 1 wherein the base plate includes means for attaching the base plate to a motor unit, said motor unit causing the mirror assembly to pivot.

9. The assembly according to claim 1 wherein the base plate holes, the reflective layer holes and the LEDs are arranged in a V-shape configuration.

10. A mirror assembly for a vehicle side mirror, said assembly comprising:
a base plate having a forward facing surface and a rearward facing surface, said base plate including a plurality of holes extending therethrough;
a mirror glass mounted to the rearward facing surface of the base plate, and
a printed circuit board mounted within a cavity formed in the forward facing surface of the base plate, said base plate including a cover plate for holding the circuit board within the cavity, said printed circuit board including a plurality of LEDs mounted thereto, said LEDs being aligned with the holes in the base plate.

11. The assembly according to claim 10 wherein the printed circuit board includes a plurality of electrical components, said electrical components causing the LEDs to be sequentially illuminated from an outermost pair of LEDs to an inner LED, said electrical components causing a previous lit outermost pair of LEDs to remain illuminated when a next outermost pair of LEDs is illuminated, and wherein all of the LEDs remain illuminated when the next outermost pair of LEDs is illuminated.

12. The assembly plate according to claim 10 wherein the cover plate is sonically welded to the forward facing surface of the base plate.

13. The assembly according to claim 10 wherein the base plate includes a first opening within the cavity and a second opening outside of the cavity, and wherein a wire electrically connected to the circuit board extends through the first opening to the rearward facing surface of the base plate and then extends through the second opening from the rearward facing surface to the forward facing surface.

14. The assembly according to claim 10 wherein the base plate includes means for securing the base plate to a motor unit, said motor unit causing the mirror assembly to pivot.

15. A mirror assembly for a vehicle side mirror, said assembly comprising:
a base plate having a forward facing surface and a rearward facing surface, said base plate including a plurality of holes extending therethrough;
a mirror glass mounted to the rearward facing surface of the base plate;
a plurality of LEDs mounted to the forward surface of the base plate and being aligned with the holes in the base plate, said plurality of LEDs being outside the periphery of the mirror glass;
a lens mounted to the rearward facing surface of the base plate adjacent and outboard to the mirror glass, said lens covering the plurality of LEDs, wherein the illumination of the LEDs is visible through the lens; and
a control device, said control device causing the LEDs to be sequentially illuminated from an outermost pair of LEDs to an inner LED where a first pair of LEDs is illuminated, then a next pair of LEDs is illuminated in sequence towards the inner LED.

16. The assembly according to claim 15 wherein the control device sequentially illuminates the LEDs so that each pair of LEDs that is illuminated remain lit as the next inner most pair of LEDs is illuminated.

17. The assembly according to claim 16 wherein the control device causes the LEDs to be sequentially illuminated until all of the LEDs are lit, said control device causing the LEDs to remain illuminated until a power signal is removed from the LEDs.

18. The assembly according to claim 15 wherein the plurality of LEDs and the control device are mounted on a printed circuit board, and wherein the printed circuit board is mounted within a cavity formed in the forward facing surface of the base plate.

19. The assembly according to claim 18 wherein the circuit board is held within the cavity by a cover plate.

20. The assembly according to claim 19 wherein the cover plate is sonically welded to the forward facing surface of the base plate.

21. The assembly according to claim 18 wherein the base plate includes a first opening within the cavity and a second opening outside of the cavity, and wherein a wire electrically connected to the circuit board extends through the first opening to the rearward facing surface of the base plate and then extends through the second opening from the rearward facing surface to the forward facing surface.

22. A mirror assembly for a vehicle side mirror, said assembly comprising:
a base plate having a forward facing surface and a rearward facing surface, said base plate including a plurality of holes extending therethrough positioned in a V-shaped configuration, said base plate including a first opening and a second opening, said base plate further including a device operable to engage a motor unit, said motor unit causing the mirror assembly to pivot;
a mirror glass mounted to the rearward facing surface of the base plate, and
a printed circuit board mounted within a cavity formed in the forward facing surface of the base plate, said base plate including a cover for holding the circuit board within the cavity, said cover plate being secured to the forward facing surface of the base plate, wherein a wire electrically connected to the circuit board extends through the first opening in the cavity to the rearward facing surface of the base plate and then extends through the second opening from the rearward facing surface to the forward facing surface outside of the cavity, said printed circuit board including a plurality of LEDs mounted thereto, said LEDs being aligned with the holes in the base plate, said printed circuit board including a plurality of electrical components, said electrical components causing the LEDs to be sequentially illuminated from an outermost pair of LEDs to an inner LED.

23. The assembly according to claim 22 wherein the printed circuit board sequentially illuminates the LEDs so that each pair of LEDs that is illuminated remains illuminated when the next outermost pair of LEDs is illuminated, and wherein the printed circuit board causes the LEDs to be sequentially illuminated until all of the LEDs are illuminated, said printed circuit board causing the LEDs to remain illuminated until a power signal is removed from the LEDs.

24. The assembly according to claim 22 wherein the mirror glass includes a reflective layer having a plurality of holes extending therethrough, said reflective holes being aligned with the base plate holes and the LEDs so that illumination of the LEDs can be seen through the mirror glass.

25. The assembly according to claim 22 further comprising a lens mounted to the rearward facing surface of the base plate adjacent and outboard to the mirror glass, said lens covering the plurality of LEDs and allowing light from the LEDs to be visible therethrough.

26. A method of assembling a vehicle side mirror, said method comprising:
providing a base plate having a forward facing surface and a rearward facing surface, said forward facing surface including a cavity, said base plate including a series of holes arranged in a V-shape;
mounting a mirror glass to the rearward facing surface of the base plate; and
mounting a printed circuit board within the cavity, said printed circuit board including a plurality of LEDs mounted to the circuit board to be aligned with the holes in the base plate, said printed circuit board further including a plurality of electrical components operable to illuminate the LEDs.

27. The method according to claim 26 further comprising mounting a cover plate over the cavity to secure the printed circuit board therein.

28. The method according to claim 26 wherein mounting a cover plate includes sonically welding the cover plate to the forward facing surface of the base plate.

29. The method according to claim 26 further comprising securing the combination of the base plate, the mirror glass and the printed circuit board to a motor unit within a side mirror housing.

30. The method according to claim 26 wherein providing a base plate includes providing a first opening and a second opening in the base plate, said first opening being in the cavity and said second opening being outside of the cavity, said method further comprising threading a wire connected to the circuit board through the first opening to the rearward facing surface of the base plate and then through the second opening to the forward facing portion of the base plate.

31. The method according to claim 26 wherein mounting a mirror glass to the rearward facing surface of the base plate includes mounting a mirror glass having a reflective layer including a series of holes aligned with the holes in the base plate.

32. The method according to claim 26 further comprising mounting a lens to the rearward facing surface of the base plate adjacent and outboard to the mirror glass so that the lens covers the LEDs.
